(19) United States
(12) Patent Application Publication
(10) Pub. No.: US 2012/0203642 A1
(43) Pub. Date: Aug. 9, 2012

(54) MILEAGE GENERATION AND OPERATION METHODS IN RELATION TO ADVERTISING COST AND AN APPARATUS THEREOF

(75) Inventors: Sang-Ho Park, Seoul (KR); Byung-Rack Son, Seoul (KR)

(73) Assignee: Sharp Kabushiki Kaaisha, Osaka (JP)

(21) Appl. No.: 13/501,818

(22) PCT Filed: Oct. 14, 2010
(86) PCT No.: PCT/KR10/07040

§ 371 Date: Apr. 18, 2012

(30) Foreign Application Priority Data
Oct. 14, 2009 (KR) 10-2009-0097529

(51) Int. Cl. G06Q 30/02

(52) U.S. Cl. 705/14.69

(57) ABSTRACT

The present invention relates to mileage generation and operation methods in relation to an advertising cost, and an apparatus thereof. When a request for a mileage service in relation to an advertising cost of an advertiser server computer is made and a type of advertising is selected, an operating server computer settles an advertising cost, generates a mileage in an e-wallet of each advertiser and then transmits mileage information to a corresponding advertiser server computer. After confirming this, the corresponding advertiser server computer sets request conditions from an advertiser (e.g., membership registration, clicking advertisement, purchasing a product, participating in an event or the like) for mileage allowance reimbursement available to users, that is, clients of the advertiser, as well as a mileage reimbursement information by request condition from the advertiser. When a user terminal connected to the operating server computer and a distribution assistance server/advertiser server computer executes a request condition from an advertiser, corresponding mileage reimbursement information (information on a subject, amount, condition or the like) having been set is then fed back to the operating server computer. Then the operating server computer automatically transfers a mileage to the e-wallet of a corresponding user from the e-wallet of a corresponding advertiser, based on the reimbursement information which has been fed back. Accordingly, the present invention can carry out efficient advertising compared to other existing online advertising services, and may promote e-commerce through the settlement and transaction of mileage reimbursement given to each user.

### TECHNICAL FIELD

The present invention relates to mileage generation and operation methods in relation to an advertising cost and an apparatus thereof

### BACKGROUND ART

Generally, internet is widely used as a specific tool for an information acquisition and intercommunication with the aid of an easier access function and a convenience in networking. The internet space becomes an ordinary life space for a variety of people over the world. An internet-based business sector such as electronic commerce might be advancing limitlessly.

The earlier mentioned developments of internet largely thank to the online advertisements. The current online advertisements using the internet might be classified into a search advertisement (keyword), a display advertisement (banner), a push-out advertisement (email), etc., which are classified depending on the procedures and types that an advertisement owner's intention is transferred to customers. The value chains of the above advertisements are directed to a simple one-way structure in which an advertisement provider (portal, media, etc.) obtains profits from the advertisement owners in such a way to expose advertisements to unanimous people by way of his contents or to help them visit. In this case, it is hard to estimate or measure the effects of advertisement and it is hard to report a specific advertisement performance to an advertisement owner now that it is impossible to specify the customers of a corresponding advertisement owner since a customer factor is eliminated from an advertisement value chain, and it is hard to reach a desired advertisement goal, and a continuous relationship between an advertisement owner and a customer cannot be maintained for a long time.

For example, the display advertisement and the search advertisement currently provided by the portals such as google, naver, etc. are directed to obtaining profits from advertisement owners based on a certain amount of traffics or the number of clicks for a set period in such a way to guide traffics to the sites of advertisement owners. The related feedback information provided to an advertisement owner of a corresponding advertisement is on traffic for charging, the number of clicks and occurrence timing. In case of the push-out type advertisement, since it is directed to a structure that an advertisement owner or a proxy of an advertisement owner forcibly pushes advertisements to a plurality of anonymous people, the customers generally tend to think that such advertisements are considered as spam, so the efficiency of advertisement is very low.

Various online advertisements such as a search advertisement, a display advertisement, a push advertisement, etc., which are currently used, have low advertisement effects and are not reasonable in the measurements of advertisement affects, so the satisfactions to advertisement owners continue to drop, and potential customers seem not to consider such advertisements as information.

So it is urgently needed to develop and provide a new online advertisement type which might becomes a convenient life tool for a user, a passage connecting all the time an advertisement owner and a customer for the internet which is a business and marketing space, and a center of profits of an advertisement owner and a customer in a structure that a distributor takes all the profits.

### DISCLOSURE OF INVENTION

### Technical Problem

Accordingly, the present invention is made to resolve the problems encountered in the conventional art, and it is an object of the present invention to provide mileage generation and operation methods in relation to an advertising cost and an apparatus thereof which are characterized in that an operator generates mileage to an advertisement expense provided from an advertisement owner, and the generated mileage is provided to a corresponding advertisement owner, and the advertisement owner provides the mileage provided from the operator to the users who are customers, and each user uses the mileage to the purchase of products or payments or transaction.

It is another object of the present invention to provide mileage generation and operation methods in relation to an advertising cost and an apparatus thereof which are characterized in that a mileage provided from an operator is provided to each user who performs a certain requirement such as an advertisement click previously set by each advertisement owner, a member subscription, an event participation, a purchase, etc.

It is further another object of the preset invention to provide mileage generation and operation methods in relation to an advertising cost and an apparatus thereof which are characterized in that both the mileage information provided from an operator to an advertisement owner and the mileage information of a user who receives a mileage obtained as he performs the requirement of each advertisement owner are managed in a form of an electronic wallet.

It is still further another object of the preset invention to provide mileage generation and operation methods in relation to an advertising cost and an apparatus thereof which are characterized in that the advertisement of each advertisement owner is registered, distributed and posted at a site managed by an operator and a distribution assistant, and the mileage information provided along with the advertisement is notified in an advertisement content or a certain purpose space of an advertisement owner or is inserted therein, so the advertisement intentions of the advertisement owner can be surely provided to potential customers of a corresponding advertisement owner.

### Technical Solution

To achieve the above objects, there are provided mileage generation and operation methods in relation to an advertising cost, comprising (1) a step in which an operation server computer processes the payment of an advertisement expense depending on a mileage service use request related with an advertisement expense of an advertisement owner server computer member-connected via a network communication network, registers, in the operation server computer, the data to be used in an advertisement, and registers, distributes and posts the data in a site being operated by the operation server computer and a distribution assistant server computer; (2) a step in which the operation sever computer generates a mileage in proportion to the advertisement expense to each advertisement owner who has paid the advertisement expense, registers in the electronic wallet of a corresponding advertisement owner and transmits the mileage information to the advertisement owner server computer; (3) a step in which the advertisement owner sever computer, which has received the mileage information related with the advertisement expense from the operation server computer sets an advertisement owner request condition so that a user, a customer of a corresponding advertisement owner, can receive mileages, and sets a mileage payment information by the advertisement owner request condition; and (4) a step in which when a user terminal member-connected, via a network communication network, with the operation server computer and the distribution assistant server computer or the advertisement owner server computer executes an advertisement owner request condition, the advertisement owner server computer feeds back the payment information of a corresponding set mileage to the operation server computer, and the operation server computer automatically transfers and accumulates the mileages from the electronic wallet of a corresponding advertisement owner to the electronic wallet of a user depending on the fed back payment information.

After the step (4), there is further provided (5) a step in which the operation server computer controls the purchase payment or the mileage payment that a user has requested, based on the reduction and transfer of the mileages accumulated in the electronic wallet of a corresponding user when the purchase payment using a mileage or the mileage payment is requested via the site associated with the operation server computer from the user terminal which has received and accumulated the mileages via the step (4).

To achieve the above objects, there is provided an apparatus of mileage generation and operation methods in relation to an advertising cost according to the present invention comprises a network communication network which connects a plurality of anonymous communication lines, thus performing a data communication in relation with a mileage service related with an advertisement expense between the same; an advertisement owner server computer which is member-logged in an operation server computer providing a mileage service in relation with an advertisement expense via the network communication network and receives from the operation server computer the mileage information generated depending on the payment of the advertisement expense and sets the advertisement owner request condition for paying the mileages generated depending on the payment of the advertisement to the users, which are the customer of the advertisement owner and sets the mileage payment information by the advertisement owner request condition; a user terminal which is member-logged in the operation server computer and a plurality of distribution assistant server computers or the advertisement owner server computer via the network communication network and executes the advertisement owner request condition set by each advertisement owner and receives the mileages that a corresponding advertisement owner has; and an operation server computer which processes the payment of the advertisement owner expense depending on the mileage service use request related with the advertisement expense of the advertisement owner server computer which member-logged in via the network communication network, and registers the data to be used for advertisement, and at the same time registers, distributes and posts in the sites being operated by the operation server computer and the distribution assistant sever computer, and registers in the electronic wallet of a corresponding advertisement owner by generating mileages to each advertisement owner who has paid the advertisement expenses in proportion to the advertisement expenses, and transfers the mileage information to the advertisement owner server computer, and receives a feedback from the advertisement owner server computer on the payment information of a corresponding set mileage when the user terminal member-logged in the operation server computer and the distribution assistant server computer or the advertisement owner server computer via the network communication network executes the advertisement owner request condition, and automatically transfers and accumulates the mileages from the electronic wallet of a corresponding advertisement owner to the electronic wallet of a corresponding user depending on the fed back payment information.

### Advantageous effects

According to the mileage generation and operation methods in relation to an advertising cost and an apparatus thereof of the present invention, both the mileage information provided from an operator to each advertisement owner in sync with advertisement expense and the mileage information provided to each user who performs the requirement of each advertisement owner (advertisement click, member subscription, event participation, purchase, etc.) are managed in a form an electronic wallet, so advertisement efficiency can be maximized by expanding a conventional advertisement process, which used to done until exposure or induction, to an exposure, an induction and a transaction, and the advertisement effects can be objectively measured by way of the statistic of mileage flow, and electronic commerce can be promoted by way of the payment of mileage provided to each user and mileage transaction behavior.

In the present invention, each advertisement owner can surely transfer the products of the advertisement owner and the whole information from the advertisement owner to the customers belonging to the advertisement owner, and the advertisements can be more effectively performed as compared to a conventional online advertisement, and a user can obtain reliable advertisement information and can purchase the products with the mileage obtained from each advertisement owner, thus saving costs.

Also, the mileage services which can be transacted between the advertisement owner who is hard to provide mileage to a customer, the seller who wants to use only the mileage irrespective of advertisement and the customer who want to change the mileage into cash are made possible in sync with advertisements, thus resolving the problems that the conventional mileage services which are distributed and are becoming useless.

### BRIEF DESCRIPTION OF DRAWINGS

FIG. 1 is a schematic bloc diagram illustrating a construction of the mileage generation and operation methods in relation to an advertising cost and an apparatus thereof according to an embodiment of the present invention.

FIG. 2 is a block diagram illustrating a construction of an operation server computer of FIG. 1.

FIG. 3 is a flow chart illustrating an operation procedure of the mileage generation and operation methods in relation to an advertising cost and an apparatus thereof according to the present invention.

FIGS. 4 through 8 are flow charts illustrating an operation procedure which is performed by each step of FIG. 3.

### MODES FOR CARRYING OUT THE INVENTION

The mileage generation and operation methods in relation to an advertising cost and an apparatus thereof according to the present invention will be described with reference to the accompanying drawings.

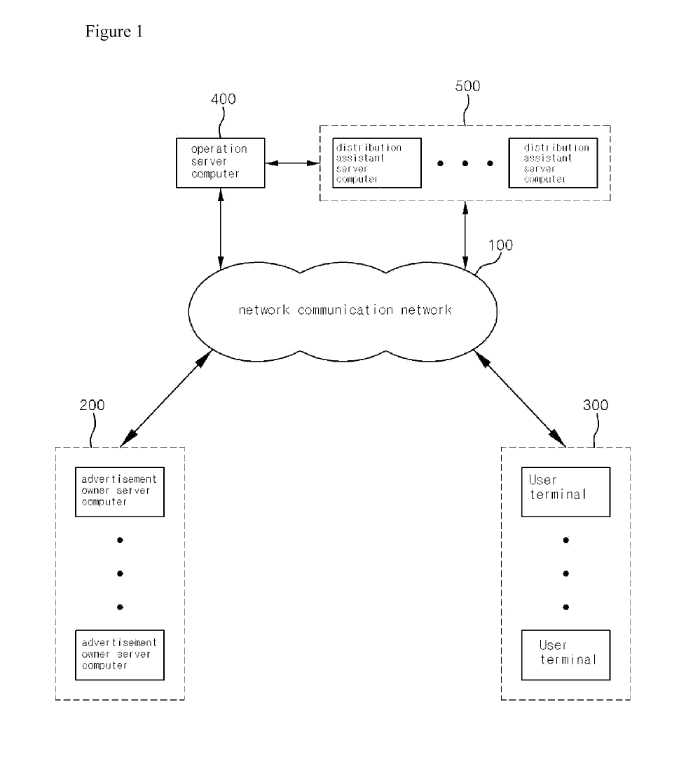

FIG. 1 is a schematic bloc diagram illustrating a construction of the mileage generation and operation methods in relation to an advertising cost and an apparatus thereof according to an embodiment of the present invention.

As shown therein, the mileage generation and operation apparatus according to the preset invention comprises a network communication network 100, a plurality of advertisement owner server computers 200, a plurality of user terminals 300, an operation server computer 400 and a plurality of distribution assistant server computers 500. The plurality of the distribution assistant server computers 500 are pure advertisement distribution places such as a press media or a blog site which obtains profits by adding an advertisement sense of google.

The network communication network 100 is a wired or wireless internet communication network serving to perform a data communication on a mileage service in relation with an advertisement cost by connecting a plurality of advertisement owners, a plurality of users, a server operator and the communication lines of the plurality of the assistants.

The plurality of the advertisement owner server computers 200 are computers managing the sites operated by the advertisement owners and are directed to performing a communication connection to the operation server computer 400 providing a mileage service related with the advertisement expense by way of the network communication network 100 based on the operation of the advertisement owner and serving to register the members of the advertisement owners. After connection, it helps pay a certain amount of advertisement expense to the side of the operation server computer 400 so as to use the mileage service related to the advertisement expense and receives the mileage information created upon the payment of the advertisement expense from the operation server computer 400. In addition, it helps set advertisement owners' various request conditions that the mileage generated by way of the advertisement expense payment is to be paid to the users who are the customer of the advertisement owner, and the mileage payment information by the various advertisement owner request conditions.

Here the advertisement owner's request conditions to be set in the advertisement owner server computer 200 for paying the mileage provided from the operation server computer 400 to the customer can be determined depending on the member subscription of the advertisement owner server computer 200 of the users, the event participations, the product purchase, and the purpose of the advertisement owner of a specific advertisement registered in the operation server computer 400 and the distribution assistant server computer 500.

The advertisement owner server computer 200 helps notify the advertisement owner request conditions, the mileage payment information and the information related with the use of the mileages that the users store by way of the sites being operated by the advertisement owner server computer 200 or helps notify the same by way of the advertisement data of a corresponding posted in the sites being operated by the operation server computer 400 and the plurality of the distribution assistant server computer 500, so the users can accumulate the mileage by keeping the various advertisement owner request conditions set by the advertisement owners.

The plurality of the user terminals 300 are directed to all kinds of instruments connectable to the internet such as a personal computer, a laptop computer, a PDF, a cellular phone, a television set, etc. which are used by common internet users. The users perform a member login to the advertisement owner server computer 200 or the operation server computer 400 and the distribution assistant server computer 500 by way of the network communication network 100, and perform the various advertisement owner request conditions set by each advertisement owner and takes part of the mileages kept in a corresponding advertisement owner. At this time, the mileages that each user took based on the executions of the advertisement owner request conditions set by each advertisement owner can be used for a purchase payment or a transaction and money conversion of mileage by way of the advertisement owner sites as well as other sites associated with the operation server computer 400.

The operation server computer 400 requests a data to be used for an advertisement expense payment and an advertisement depending on the mileage service use requests related to the advertisement expense of the advertisement owner server computer 200 which member-logged in by way of the network communication network 100. When the advertisement expense payment of a corresponding advertisement owner server computer 200 is finished, the advertisement data provided together is registered, and at the same time it is registered, distributed, posted here, (At this time, the advertisement data can be posted, registered and distributed in the site being operated by the advertisement owner server computer 200) to the sites being operated by the operation server computer and the distribution assistant server computer 500. In addition, a mileage is generated in proportion to the advertisement expense to each advertisement owner who has paid the advertisement expense and is registered in an electronic wallet of the advertisement owner. The mileage information is transferred to a corresponding advertisement owner server computer 200, so each advertisement owner performs various promotions using the mileage. The advertisement data (processed data including mileage payment information) of each advertisement owner who registers, distributes and posts in the sites being operated by the operation server computer 400 and the distribution assistant server computer 500 corresponds to one advertisement owner request condition under which each advertisement owner pays mileages to his customer, and each advertisement owner can pay only the costs without providing an additional advertisement date to the operation server computer 400 when performing a service use application and can receive mileage, and the received mileages can be used for the purpose of promotion. Since the present invention is implemented based on a minus mileage system in which mileages are first given, and then the payment is performed, the transaction of only the mileages not related with the advertisement expense can be conducted or the charges might be requested in proportion to the mileages consumed after the advertisement depending on the type of advertisement or the sale amount. Various modifications might be possible.

The operation server computer 400 receives a feedback on the payment information of a corresponding mileage from the advertisement owner server computer 200 when a member logins the operation server computer 400 and the distribution assistant server computer 500 via the network communication network 100 or the use terminal 300 member-logged in the advertisement owner server computer 200 performs various advertisement owner request conditions that the advertisement owners set for the payments of the mileages, and a mileage is automatically transferred and accumulated in the electronic wallet of a corresponding electronic wallet (virtual account) of a corresponding advertisement owner depending on the payment information fed back from the advertisement owner server computer 200. At this time, the operation server computer 400 does not need to check the history of the transaction conducted between the advertisement owner and the user, and only the transfer of the mileage simply conducted between the advertisement owner and a specific user and the report and inquiry of the contents concerning the transfer are processed.

Also, the operation server computer 400 stores the mileages of each user within a set limit of the mileage generating in connection with the advertisement cost that each advertisement owner has paid. When all the mileages paid as the advertisement owner request conditions are performed by means of each user are consumed, it is reported that what the payment of the mileage is finished can be reported to the user terminal 300 and a corresponding advertisement owner server computer 200. In addition, the history of the transfer based on the payment of mileage can be immediately reported to a corresponding advertisement owner server computer 200 and the user terminal 300, and each advertisement owner and users can inquiry his own mileage information at any time.

Also, the operation server computer 400 processes a purchase payment or a mileage payment requested by a transaction person by way of the reduction of the mileage accumulated in the electronic wallet of a corresponding user and its transfer when the user terminal 300 what has received the mileage by performing the advertisement owner request condition set by each advertisement owner requests a purchase payment based on the use of mileage via other sites (namely, the site might be an electronic commerce site that wants a payment via mileage by providing a user with 100 mileages) associated with the operation server computer 400 or the advertisement owner's site, or a transaction of mileage and money conversion. Here, the use of the mileage accumulated by each user might be adapted to all the applications which are currently available in addition to the purchase payment, cash payment, etc.

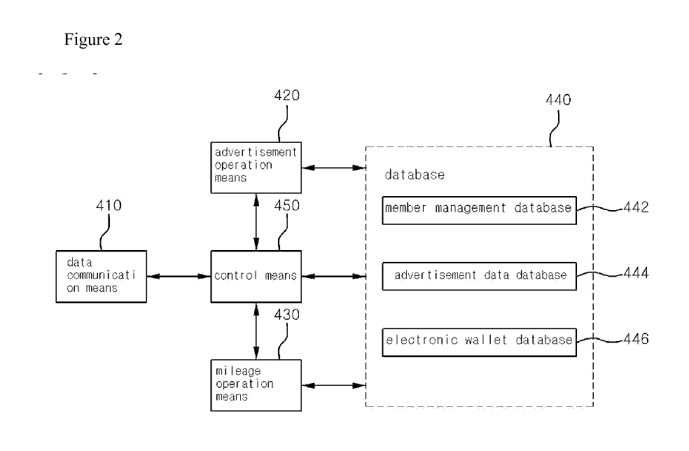

FIG. 2 is a block diagram illustrating a construction of the operation server computer 400 of FIG. 1.

As shown therein, the operation server computer 400 comprises a data communication unit 410, an advertisement operation unit 420, a mileage operation unit 430, a database 440 and a control unit 450.

The data communication unit 410 processes a data transmission and receiving on the mileage information generated based on the mileage service use request relate with the advertisement owner server computer 200 member-logged in via the network communication network 100 and the advertisement expense, the advertisement expense payment, the registration of the data to be used in the advertisement and the payment of the advertisement expense. In addition, it further processes the data transmission and receiving on the executions of the user terminal 300 member-logged in via the network communication network 100 and the advertisement owner request condition, and the mileage information paid based on the executions of the advertisement owner request conditions and the use information of the accumulated mileage.

The advertisement operation unit 420 helps register the data to be used for the advertisement of each advertisement owner received via the data communication unit 410, and processes the registration, distribution and posting in the site being operated by the operation server computer 400 and the distribution assistant server computer 500.

The mileage operation unit 430 controls the information of the programs, which are capable of automatically checking out whether each advertisement owner request condition is executed or not, in the advertisement data of each advertisement owner posted in the plurality of the advertisement owner server computers 200, the operation server computer 400 and the plurality of the distribution assistant server computers 500, and checks out whether the user terminal 300 member-logged in via the operation server computer 400 and the distribution assistant server computer 500 or the advertisement owner server computer 200 as the program starts operating executes a specific advertisement owner request condition set by each advertisement owner or not. When the specific advertisement owner request condition is executed by a user, it receives a feedback of the payment information of a corresponding mileage from the advertisement owner server computer 200 and processes the automatic transfer to the electronic wallet of a corresponding user from a specific advertisement owner based on the fed back payment information.

The database 440 stores the member registration information of each advertisement owner and each user who use the mileage service related with the advertisement expense, the registration and use information of the data to be used for advertisement, the transfer information of the mileage in proportion to the advertisement expense paid by each advertisement owner based on the electronic wallet by each advertisement owner and user who registered as a member, and a mileage accumulation and use information based on the execution of the advertisement owner's request condition of by each user.

The database 440 comprises a member management database 442 which stores the information provided when each advertisement owner and each user register as a member for using the mileage services related with the advertisement expense, an advertisement data database 444 which accumulates and stores the data to be used for the advertisements provided from each advertisement owner who requested a mileage service related to the advertisement expense and the use information of a corresponding advertisement data, and an electronic wallet database 446 which stores the transfer and accumulation information of the mileage moved from the advertisement owner to the user and the detailed information on the advertisement owner's request condition necessarily executed for the acquisition of the mileage, the time, amount, and transfer/reduction information.

The control unit 450 controls the whole operations of the data communication unit 410, the advertisement operation unit 420, the mileage operation unit 430 and the database 440.

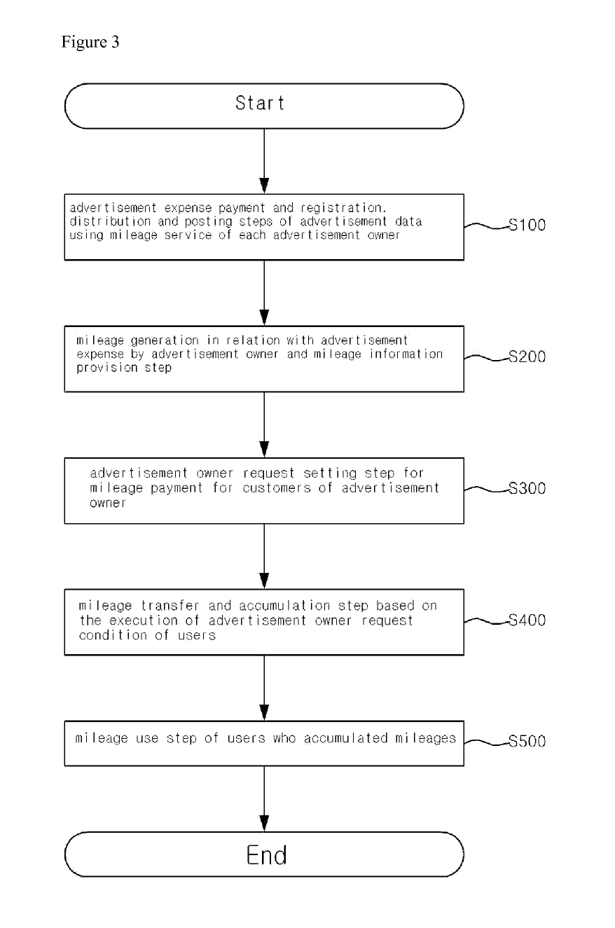

Next, the embodiment of the mileage generation and operation methods in relation to an advertising cost according to the present invention will be described with reference to FIGS. 3 to 8.

FIGS. 3 to 8 are flow charts illustrating the operation procedures of the mileage generation and operation methods in relation to an advertising cost according to the present invention.

The operation server computer 400 processes the payment of the advertisement expense depending on the mileage service use request related with the advertisement expense of the advertisement owner server computer 200 member-logged in via the network communication network 100, and registers the data to be used for advertisement in the operation server computer 400, and registers, distributes and posts on the sites being operated by the operation server computer 400 and the plurality of the distribution assistant server computer 500(S100).

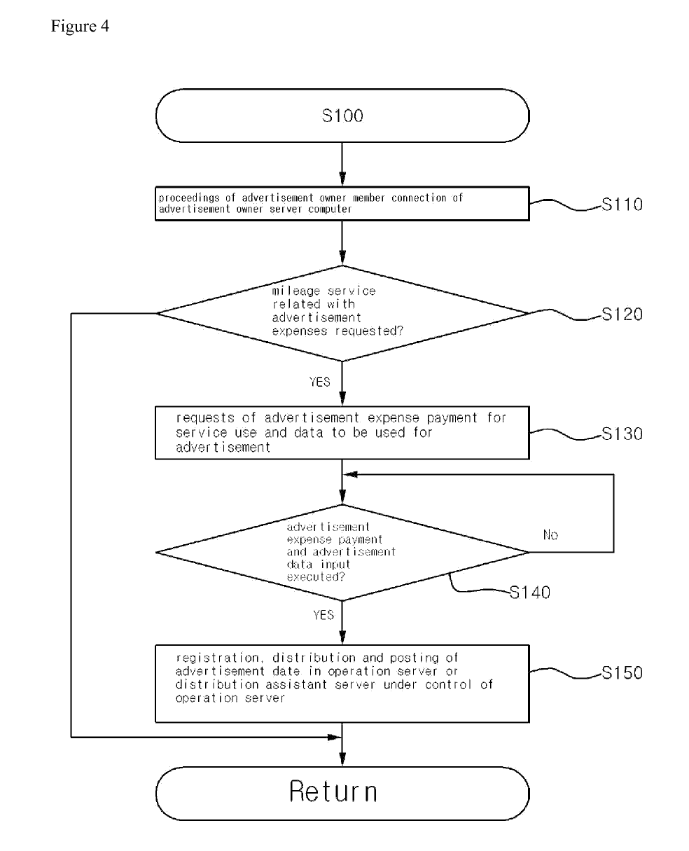

The step S100 will be described in details with reference to FIG. 4. The operation server computer 400 performs a member connection of the advertisement owner server computer 200 member-logged in via the network communication network 100 (S110), and judges whether the user request related with the advertisement expense is finished from the advertisement owner server computer 200 or not (S120).

When the use request of the mileage service related with the advertisement expense is done from the advertisement owner server computer 200, the operation server computer 400 requests, to a corresponding advertisement owner server computer 200, a transmission of the data to be used for the advertisement expense payment and advertisement for the service use (S130), and judges whether the inputs of the payment of the advertisement expense and advertisement data are done or not based on the data information inputted from the advertisement owner server computer 200 (S140).

When the payment of the advertisement expense and the advertisement data are inputted from the advertisement owner server computer 200, the operation server computer 400 processes the advertisement data (namely, the advertisement data are processed to include the mileage payment information set by a corresponding advertisement owner and are so processed that the users can recognize in a set forma and size), and registers in the operation server computer 400, and then registers, distributes and posts in the sites being operated by the operation server computer 400 and the plurality of the distribution assistant server computer 500 (S150).

The operation server computer 400 which has received the advertisement expense from each advertisement owner via the step S100 generates mileage in proportion to the advertisement expense, and transfers the generated mileage information to a corresponding advertisement owner server computer 200 (S200).

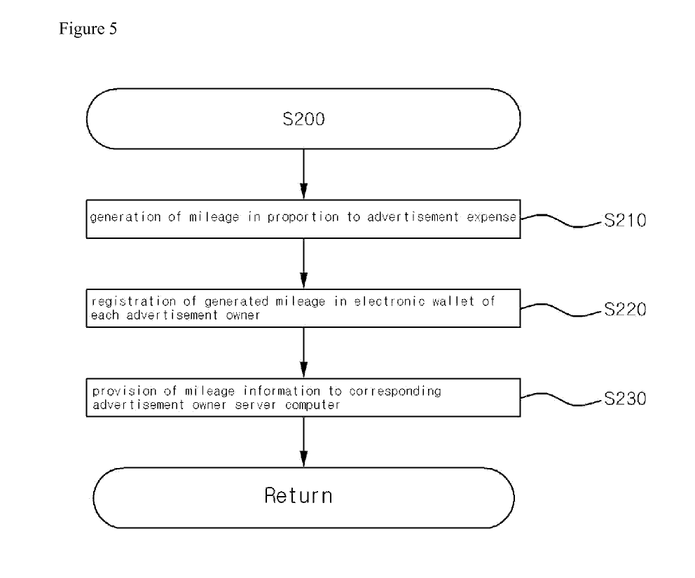

The step S200 will be described in details with reference to FIG. 5. The operation server computer 400 generates mileage in proportion to the advertisement expense that each advertisement owner has paid (S210), and registers the generated mileage in the electronic wallet of a corresponding advertisement owner (S220), and transfers the generated mileage information to a corresponding advertisement owner server computer 200 via the network communication network 100 (S230).

The advertisement owner server computer 200, which has received the mileage information related to the advertisement expense from the operation server computer 400 via the step S200, sets the advertisement owner request conditions for the users corresponding to the customers of the advertisement owner to receive mileages, and the mileage payment information by the advertisement owner request condition (S300).

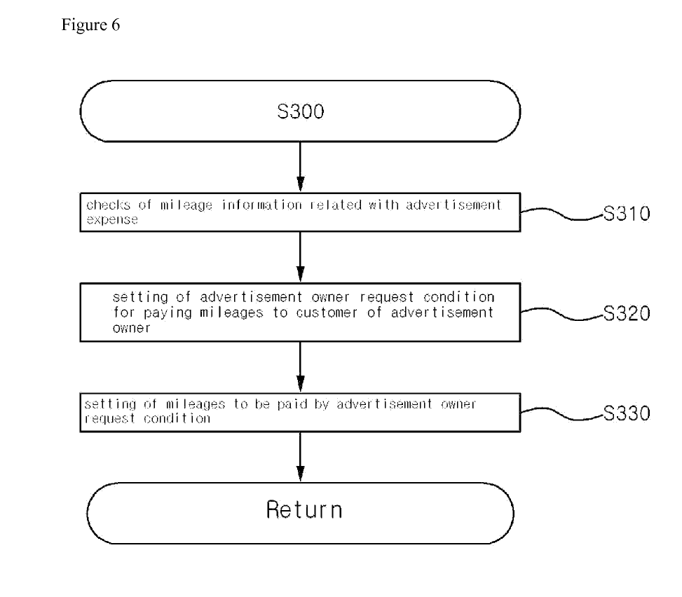

The step S300 will be described in details with reference to FIG. 6. The advertisement owner server computer 200 checks out the mileage information generated in relation with the advertisement expense provided from the operation server computer 400 (S310).

The advertisement owner server computer 200 sets various advertisement owner request conditions for receiving a corresponding mileage to conduct a promotion with respect to the customers of the advertisement owner (S320), and sets how much mileage is to be paid depending on each advertisement owner request condition (S330).

In other words, each advertisement owner sets various advertisement owner request conditions and a payment amount of mileage by various advertisement owner request conditions by which the mileages can be paid depending on the member subscriptions of the users who visit the sites of the advertisement owner, the event participation, the purchase of the product and service, and the advertisement clicks registered in the operation server computer 400 and the distribution assistant server computer 500.

Each advertisement owner might notify an advertisement owner request condition and a mileage payment information and an information regarding the use of the mileages that the each user accumulates in the sites being operated by the advertisement owner server computer 200 or might notify using the advertisement data of a corresponding advertisement owner disclosed in the sites being operated and controlled by the operation server computer 400 and the distribution assistant server computer, so that each user can check out the notified information.

After various advertisement owner request conditions of each advertisement owner who has obtained the mileages related to the advertisement expense via the step S300 and the setting of the mileage payment are all completed, the operation server computer 400 automatically transfers and accumulates the mileages to the electronic wallet of a corresponding user from the electronic wallet of a specific advertisement owner depending on the feedback of the mileage payment information depending on the executions of an advertisement owner request condition of the user terminal 300 member-member-logged in the operation server computer 400 and the distribution assistant server computer 500 or the advertisement owner server computer 200 (S400).

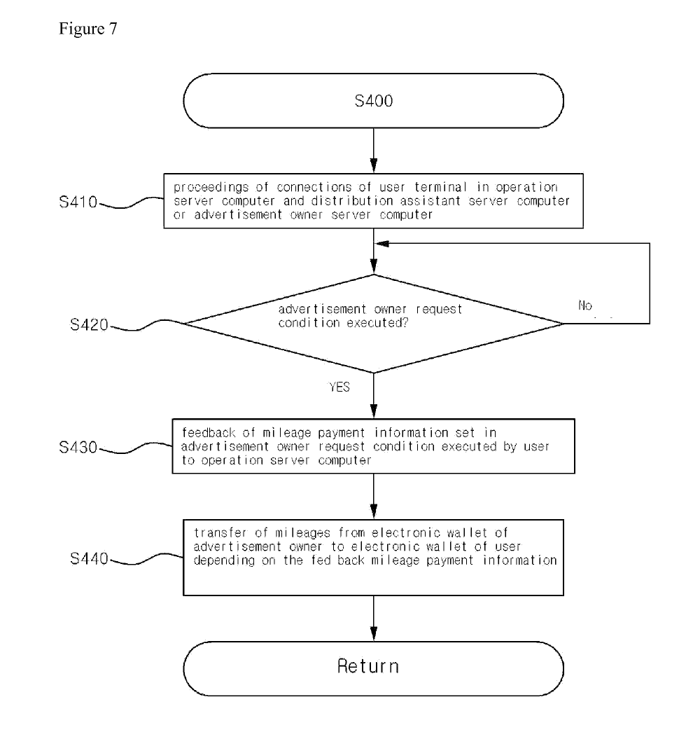

The step S400 will be described in details with reference to FIG. 7. The operation server computer 400 and the distribution assistant server computer 500 or the advertisement owner server computer 200 perform the member connections of the user terminal 300 communication-connected via the network communication network 100 (S410), and it is judged whether an advertisement owner request condition is executed or not from the user terminal 300 which is member-connected (S420).

As a result of the judgment, when an advertisement owner request condition is executed from the user terminal 300, the advertisement owner server computer 200 feedbacks the mileage payment information set based on a corresponding advertisement owner request condition to the operation server computer 400 (S430). In other words, the information and detailed information on whether one among various advertisement owner request conditions set by each advertisement owner is executed or not via the step S420 in the advertisement owner server computer 200 is transferred to the operation server computer 400.

The operation server computer 400 automatically transfers the mileages to the electronic wallet of a corresponding user from a specific advertisement owner based on the mileage payment information fed back from the advertisement owner server computer 200 (S440).

The mileages related with the advertisement expense paid to each advertisement owner in the above manner are paid to each user. The mileages accumulated by each user are determined within a limit of the mileages related with the advertisement expenses that an advertisement owner receives from the operation server computer 400. When all the mileages provided based on the execution of an advertisement owner request condition by each user are consumed, the operation server computer 400 might report that the payment of the mileages is ended, to the user terminal 300 executing the advertisement owner request condition and a corresponding advertisement owner server computer 200.

Here, the electronic wallet in which the mileages managed by the operation server computer 400 are accumulated is generated by each advertisement owner and each user based on an advertisement owner recognition code provided when an advertisement owner registers a member and a user recognition code which is created when installing a program which contains a code generator for automatically checking out whether the advertisement owner request condition is executed or not in the user terminal. In addition, the electronic wallet stores the detailed information on an advertisement owner request condition for which mileages are supposed to be collected, and the time, amount, transfer/reduction along with the transfer and accumulation information of the mileages moved from the advertisement owner to the user as the execution of the advertisement owner request condition set by each advertisement owner is performed.

After each user receives and accumulates the mileages by executing various advertisement owner request conditions via the step S400, the operation server computer 400 controls the purchase payment requested by a user or the mileage transfer or the payment based on the mileages accumulated in the electronic wallet of a corresponding user depending on the purchase payment or mileage payment request using the mileages of the user terminal 300 connected to the site associated with the operation server computer 400 (S500).

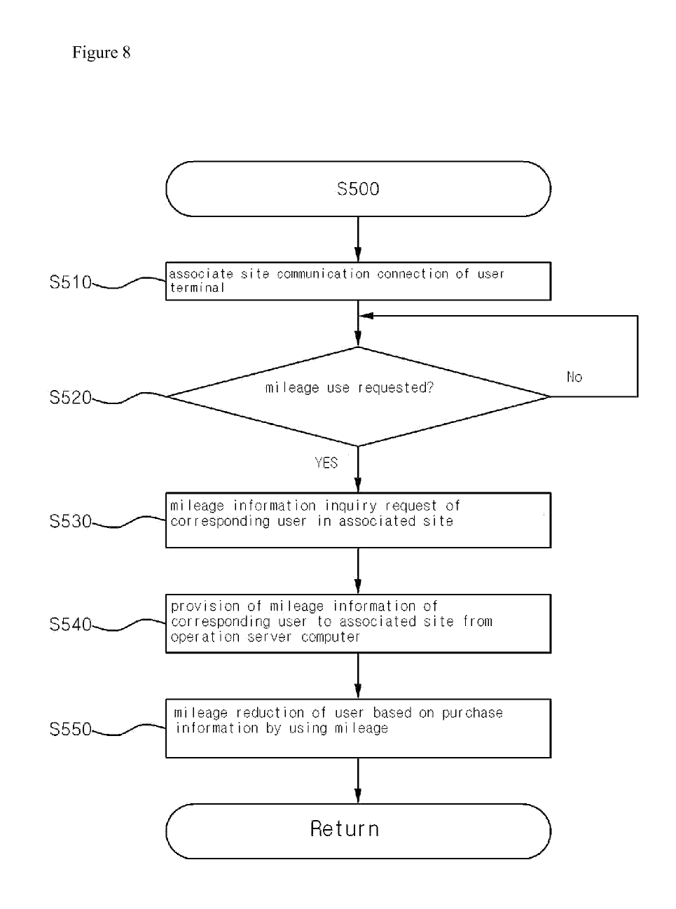

The step S500 will be described in details with reference to FIG. 8. The user terminal 300 is communication-connected with the other sites (for example, electronic commerce site, etc.) associated with the operation server computer 400 depending on a user's operation (S510), and the associated site judges whether or not a corresponding user, who is communication-connected, selects the purchase payment or mileage payment by using the mileages accumulated in the operation server computer 400 (S520).

As a result of the judgment, when it is judged that a corresponding user has selected a purchase payment using a mileage in the associated site or a mileage payment, the corresponding associated site requests, the operation server computer 400, an inquiry of the mileage information of a corresponding user who has selected a purchase payment using the mileage or the mileage payment (S530), and the operation server computer 400 compares the recognition code of a corresponding user who has requested the purchase payment using the mileage or the mileage payment based on the inquiry request of a corresponding associated site, and provides a payable mileage information to the associated site, and processes the purchase payment or the mileage payment that the user has requested in the associated site (S540).

Next, the operation sever computer 400 reduces the mileages accumulated in the electronic wallet of a corresponding user based on the purchase information (for example, a mileage purchase slip with mileage amount, seller, date, contents, etc. recorded thereon) using the mileages of a corresponding user inputted from the associated site, thus processing the purchase payment or the mileage payment what the user has requested (S550).

In other words, when a corresponding associated site and a user are supposed to transact using mileages, the operation server computer 400 checks out whether or not the payment or mileage payment is possible based on the electronic wallet information of a corresponding user depending on the request from the associated site and provides information thereon, and when the purchase payment or the mileage payment is requested via the associated site, the purchase payment or the mileage payment that a user has requested is conducted along with the reduction of the mileages accumulated in the electronic wallet of a corresponding user.

As described above, in terms of the implementations of the online advertisement, it is possible to objectively measure the advertisement effects by analyzing the mileages flow between the advertisement owner and the customer in which induction, exposure, payment, recollection, etc. are usually performed, and the advertisement efficiency can be maximized by way of a multi-step sale promotion using the distributions of mileages while the advertisement expenses can be reduced.

The present invention was described along with a preferred embodiment, but it is obvious that an ordinary person skilled in the art can variously change or modify the present invention without departing from the concept and claims of the present invention recited in the following claims.

1. Mileage generation and operation methods in relation to an advertising cost, comprising:
(1) a step in which an operation server computer processes the payment of an advertisement expense depending on a mileage service use request related with an advertisement expense of an advertisement owner server computer member-connected via a network communication network, registers, in the operation server computer, the data to be used in an advertisement, and at the same time registers, distributes and posts the data in a site being operated by the operation server computer and a distribution assistant server computer;
(2) a step in which the operation sever computer generates a mileage in proportion to the advertisement expense to each advertisement owner who has paid the advertisement expense, registers in the electronic wallet of a corresponding advertisement owner and transmits the mileage information to the advertisement owner server computer;
(3) a step in which the advertisement owner sever computer, which has received the mileage information related with the advertisement expense from the operation server computer, sets an advertisement owner request condition so that a user, a customer of a corresponding advertisement owner, can receive mileages, and sets a mileage payment information by the advertisement owner request condition; and
(4) a step in which when a user terminal member-connected, via a network communication network, with the operation server computer and the distribution assistant server computer or the advertisement owner server computer executes an advertisement owner request condition, the advertisement owner server computer feeds back the payment information of a corresponding set mileage to the operation server computer, and the operation server computer automatically transfers and accumulates the mileages from the electronic wallet of a corresponding advertisement owner to the electronic wallet of a user depending on the fed back payment information.

2. Mileage generation and operation methods in relation to an advertising cost according to claim 1, after the step (4), further comprising:
(5) a step in which the operation server computer controls the purchase payment or the mileage payment that a user has requested, based on the reduction and transfer of the mileages accumulated in the electronic wallet of a corresponding user when the purchase payment using a mileage or the mileage payment is requested via the site associated with the operation server computer from the user terminal which has received and accumulated the mileages via the step (4).

3. Mileage generation and operation methods in relation to an advertising cost according to claim 1, wherein said advertisement owner request condition of the step (3) is formed of a click of an advertisement registered in the operation server computer of a user using the user terminal or the distribution assistant server computer, a member subscription of the advertisement owner server computer, an event participation and a product purchase.

4. Mileage generation and operation methods in relation to an advertising cost according to claim 1, wherein said advertisement owner server computer which has set the advertisement owner request condition and the mileage payment information via the step (3) notifies, in the site being operated by the advertisement owner server computer, the advertisement owner request condition and the mileage payment information and the information on the use of the mileage that each user stores or notifies via an advertisement data of a corresponding advertisement owner notified in the site being operated and controlled by the operation server computer.

5. Mileage generation and operation methods in relation to an advertising cost according to claim 1, wherein the mileages accumulated by each user via the step (4) are used within the mileage limits related with the advertisement expense that the advertisement owner receives from the operation server computer, and when all the mileages given based on the executions of the advertisement owner request condition by each user are consumed, it is reported that the mileage payment is finished, to the user terminal and a corresponding advertisement owner which are supposed to execute the advertisement owner request condition.

6. Mileage generation and operation methods in relation to an advertising cost according to claim 1, wherein the electronic wallet which accumulates the mileages of the step (4) is generated by each advertisement owner and each user based on an advertisement owner recognition code provided when an advertisement owner registers a member and a user recognition code which is created when installing a program which contains a code generator for automatically checking out whether the advertisement owner request condition is executed or not in the user terminal, and the electronic wallet stores the detailed information on an advertisement owner request condition for which mileages are supposed to be collected, and the time, amount, transfer/reduction along with the transfer and accumulation information of the mileages moved from the advertisement owner to the user as the execution of the advertisement owner request condition set by each advertisement owner is performed.

7. A recording medium readable by a computer having a computer program which can be operated by a computer using the methods of claim 1.

8. An apparatus of mileage generation and operation methods in relation to an advertising cost, comprising:
a network communication network which connects a plurality of anonymous communication lines, thus performing a data communication in relation with a mileage service related with an advertisement expense between the same;
an advertisement owner server computer which is member-logged in an operation server computer providing a mileage service in relation with an advertisement expense via the network communication network and receives from the operation server computer the mileage information generated depending on the payment of the advertisement expense and sets the advertisement owner request condition for paying the mileages generated depending on the payment of the advertisement to the users, which are the customer of the advertisement owner and sets the mileage payment information by the advertisement owner request condition;
a user terminal which is member-logged in the operation server computer and a plurality of distribution assistant server computers or the advertisement owner server computer via the network communication network and executes the advertisement owner request condition set by each advertisement owner and receives the mileages that a corresponding advertisement owner has; and
an operation server computer which processes the payment of the advertisement owner expense depending on the mileage service use request related with the advertisement expense of the advertisement owner server computer which member-logged in via the network communication network, and registers the data to be used for advertisement, and at the same time registers, distributes and posts in the sites being operated by the operation server computer and the distribution assistant sever computer, and registers in the electronic wallet of a corresponding advertisement owner by generating mileages to each advertisement owner who has paid the advertisement expenses in proportion to the advertisement expenses, and transfers the mileage information to the advertisement owner server computer, and receives a feedback from the advertisement owner server computer on the payment information of a corresponding set mileage when the user terminal member-logged in the operation server computer and the distribution assistant server computer or the advertisement owner server computer via the network communication network executes the advertisement owner request condition, and automatically transfers and accumulates the mileages from the electronic wallet of a corresponding advertisement owner to the electronic wallet of a corresponding user depending on the fed back payment information.

9. An apparatus of mileage generation and operation methods in relation to an advertising cost according to claim 8, wherein said advertisement owner request condition to be set by the advertisement owner server computer for paying the mileages is formed of a click of advertisements registered in the operation server computer and the distribution assistant server computer, a member subscription of the advertisement owner server computer, an event participation, and a product purchase.

10. An apparatus of mileage generation and operation methods in relation to an advertising cost according to claim 8, wherein said advertisement owner server computer is directed to notifying the advertisement owner request condition and the mileage payment information and the information on the use of the mileage that each user accumulates, in the site being operated by the advertisement owner server computer or is directed to notifying via the advertisement data of a corresponding advertisement owner notified in the site being operated and controlled by the operation server computer and the distribution assistant server computer.

11. An apparatus of mileage generation and operation methods in relation to an advertising cost according to claim 8, wherein said operation server computer processes the purchase payment or the mileage payment requested by a transaction person by way of the reduction and transfer of the mileages accumulated in the electronic wallet of a corresponding user when a purchase payment or a mileage payment using the mileage via the other site associated with the operation server computer is received from the user terminal which has received and accumulated the mileages by performing an advertisement owner request condition set by each advertisement owner.

12. An apparatus of mileage generation and operation methods in relation to an advertising cost according to claim 8, wherein said operation server computer processes the mileage accumulations of each user within the limits of mileages generated in relation with the advertisement expenses that each advertisement owner has paid, and notifies that the mileage payment is finished, to the user terminal and a corresponding advertisement owner which are supposed to execute the advertisement owner request conditions when all the mileages paid depending on the executions of the advertisement owner request condition by each user are consumed.

13. An apparatus of mileage generation and operation methods in relation to an advertising cost according to claim 8, wherein said operation server computer comprises:
a data communication means which processes a data transmission and receiving on the mileage information generated based on the mileage service use request relate with the advertisement owner server computer member-logged in via the network communication network and the advertisement expense, the advertisement expense payment, the registration of the data to be used in the advertisement and the payment of the advertisement expense, and further processes the data transmission and receiving on the executions of the user terminal member-logged in via the network communication network and the advertisement owner request condition, and the mileage information paid based on the executions of the advertisement owner request conditions and the use information of the accumulated mileage;
an advertisement operation means which helps register the data to be used for the advertisement of each advertisement owner received via the data communication means, and processes the registration, distribution and posting in the site being operated by the operation server computer and the distribution assistant server computer;
a mileage operation means which controls the information of the programs, which are capable of automatically checking out whether each advertisement owner request condition is executed or not, in the advertisement data of each advertisement owner posted in the plurality of the advertisement owner server computers, the operation server computer and the plurality of the distribution assistant server computers, and checks out whether the user terminal member-logged in via the operation server computer and the distribution assistant server computer or the advertisement owner server computer as the program starts operating executes a specific advertisement owner request condition set by each advertisement owner or not, and when the specific advertisement owner request condition is executed by a user, it receives a feedback of the payment information of a corresponding mileage from the advertisement owner server computer and processes the automatic transfer to the electronic wallet of a corresponding user from a specific advertisement owner based on the fed back payment information; and
a database which stores the member registration information of each advertisement owner and each user who use the mileage service related with the advertisement expense, the registration and use information of the data to be used for advertisement, the transfer information of the mileage in proportion to the advertisement expense paid by each advertisement owner based on the electronic wallet by each advertisement owner and user who registered as a member, and a mileage accumulation and use information based on the execution of the advertisement owner's request condition of by each user; and
a control means which controls the whole operations of the data communication means, the advertisement operation means, the mileage operation means and the database.

14. An apparatus of mileage generation and operation methods in relation to an advertising cost according to claim 13, wherein said database comprises:
a member management database which stores the information provided when each advertisement owner and each user register as a member for using the mileage services related with the advertisement expense;
an advertisement data database which accumulates and stores the data to be used for the advertisements provided from each advertisement owner who requested a mileage service related to the advertisement expense and the use information of a corresponding advertisement data; and
an electronic wallet database which stores the transfer and accumulation information of the mileage moved from the advertisement owner to the user and the detailed information on the advertisement owner's request condition necessarily executed for the acquisition of the mileage, the time, amount, and transfer/reduction information depending on the execution of an advertisement owner request condition set by each advertisement owner by using the electronic wallets generated by each advertisement owner and each user based on an advertisement owner recognition code given when the member of the advertisement owner registers and a user recognition code which is generated when a member of a user registers or is generated during the installation of a program containing a code generator for the purpose of automatically checking whether or not the advertisement owner request condition is executed in the user terminal.
